(19) United States
(12) Patent Application Publication
(10) Pub. No.: US 2025/0383866 A1
(43) Pub. Date: Dec. 18, 2025

(54) SMART SYSTEM FOR MANAGING FIRMWARE UPDATES IN A BUILDING CONTROL SYSTEM

(71) Applicant: Honeywell International Inc., Charlotte, NC (US)

(72) Inventors: Ravi Bharathi Krishna, Bangalore (IN); Anshuman Sharma, Bhiwani (IN); Rajat Saha, Bangalore (IN); Qinghua Wang, Beijing (CN)

(21) Appl. No.: 19/240,804

(22) Filed: Jun. 17, 2025

(30) Foreign Application Priority Data
Jun. 18, 2024 (IN) 202411046736

(51) Int. Cl. G06F 8/656; G05B 15/02

(52) U.S. Cl. CPC G06F 8/656; G05B 15/02

(57) ABSTRACT

A system and method for updating firmware in a Building Management System (BMS) includes a BMS controller connected to field devices via a field bus and to a firmware (FW) management tool via a network. The BMS controller requests device information including current FW versions from the field devices and sends this information to the FW management tool. The FW management tool determines which devices have outdated firmware and sends updated versions to the BMS controller, which routes them to the appropriate field devices for installation. The system allows the FW management tool to disconnect after sending updates without disrupting installation. For devices with multiple firmware files, the FW management tool sends files sequentially, waiting for each download to complete before sending the next. The field devices can notify the BMS controller of successful installations, which can then notify the FW management tool.

### RELATED APPLICATIONS

This application claims the benefit of Indian Provisional Application No. 202411046736, filed Jun. 18, 2024, which application is incorporated herein by reference in its entirety.

### TECHNICAL FIELD

The present disclosure relates generally to building control systems, and more particularly to intelligently managing firmware updates within a building control system.

### BACKGROUND

A building control system (BMS) may include a large number of different BMS field devices. Many, if not all, of the BMS field devices employ firmware that helps to run each of the BMS field devices. Firmware may periodically be updated. Because there can be a large number of BMS field devices, and because communication channels with the BMS System may be limited in bandwidth, downloading and installing firmware updates can be a time consuming and tedious process. Moreover, in some cases, only some BMS field devices may need a particular firmware update, meaning that time and bandwidth is wasted if firmware updates are downloaded not only to BMS field devices that need a particular firmware update, but also to BMS field devices that do not need a particular firmware update. As an example, a more recently installed BMS field device may already have a particular firmware update while a BMS field device that was installed earlier may not yet have that firmware update. What would be desirable are systems and methods for intelligently managing firmware updates in a BMS system.

### SUMMARY

The present disclosure pertains generally to building control systems, and more particularly to intelligently managing firmware updates within a building control system. An example may be found in a system that includes a Building Management System (BMS) controller, a plurality of BMS Field devices that are operatively coupled to the BMS controller via a field bus, and a firmware (FW) management tool that is operatively coupled to the BMS controller via a network connection. In some cases, the BMS controller is configured to send a request over the field bus to each of the plurality of BMS field devices requesting device information including a current FW version of the respective BMS field device. In response to the request from the BMS controller over the field bus, each of the plurality of BMS field devices is configured to return the requested device information including the current FW version of the respective BMS field device to the BMS controller via the field bus. The BMS controller is configured to send at least some of the device information including the current FW version of each of the plurality of BMS field devices to the FW management tool. After receiving the device information including the current FW version of each of the plurality of BMS field devices, the FW management tool is configured to determine which of the plurality of BMS field devices have an outdated FW version. The FW management tool is configured to send one or more updated FW versions to update each of the plurality of BMS field devices identified by the FW management tool as having an outdated FW version to the BMS controller. In response to receiving the one or more updated FW versions for updating the plurality of BMS field devices identified by the FW management tool as having an outdated FW version, the BMS controller is configured to send the respective updated FW version to the respective BMS field device via the field bus. After receiving the respective updated FW version, each of the plurality of BMS field devices identified by the FW management tool as having an outdated FW version is configured to install the respective updated FW version.

Another example may be found in a method for updating firmware (FW) of a plurality of BMS field devices that are operatively coupled to a Building Management System (BMS) controller via a field bus, wherein the BMS controller is operatively coupled to a firmware (FW) management tool via a network. The method includes the BMS controller querying each of the plurality of BMS field devices that are operatively coupled to the BMS controller via the field bus for device information including a current FW version of the respective BMS field device. The BMS controller sending at least some of the device information including the current FW version of each of the plurality of BMS field devices to the FW management tool. The FW management tool determines which of the plurality of BMS field devices have an outdated FW version. The FW management tool sends one or more updated FW versions to update each of the plurality of BMS field devices identified by the FW management tool as having an outdated FW version to the BMS controller. The BMS controller routes the one or more updated FW versions to the respective BMS field devices via the field bus.

Another example may be found in a non-transitory, computer-readable storage medium storing executable instructions. When the executable instructions are executed by one or more processors of a BMS controller, the one or more processors are caused to query each of a plurality of BMS field devices that are operatively coupled to the BMS controller for device information including a current FW version of the respective BMS field device. The one or more processors are caused to send at least some of the device information including the current FW version of each of the plurality of BMS field devices to a firmware (FW) management tool. The one or more processors are caused to receive from the FW management tool one or more updated FW versions to update each of a plurality of BMS field devices identified by the FW management tool as having an outdated FW version. The one or more processors are caused to route the one or more updated FW versions to the respective BMS field devices identified by the FW management tool as having an outdated FW version.

The preceding summary is provided to facilitate an understanding of some of the innovative features unique to the present disclosure and is not intended to be a full description. A full appreciation of the disclosure can be gained by taking the entire specification, claims, figures, and abstract as a whole.

### BRIEF DESCRIPTION OF THE FIGURES

The disclosure may be more completely understood in consideration of the following description of various examples in connection with the accompanying drawings, in which:

FIG. 1 is a schematic block diagram showing an illustrative system;

FIG. 2 is a flow diagram showing an illustrative method for updating firmware of a plurality of Building Management System (BMS) devices; and

FIG. 3 is a flow diagram showing an illustrative series of steps that may be carried out by one or more processors of a BMS controller executing executable instructions that are stored on a non-transient, computer-readable storage medium.

While the disclosure is amenable to various modifications and alternative forms, specifics thereof have been shown by way of example in the drawings and will be described in detail. It should be understood, however, that the intention is not to limit the disclosure to the particular examples described. On the contrary, the intention is to cover all modifications, equivalents, and alternatives falling within the spirit and scope of the disclosure.

### DESCRIPTION

The following description should be read with reference to the drawings, in which like elements in different drawings are numbered in like fashion. The drawings, which are not necessarily to scale, depict examples that are not intended to limit the scope of the disclosure. Although examples are illustrated for the various elements, those skilled in the art will recognize that many of the examples provided have suitable alternatives that may be utilized.

All numbers are herein assumed to be modified by the term “about”, unless the content clearly dictates otherwise. The recitation of numerical ranges by endpoints includes all numbers subsumed within that range (e.g., 1 to 5 includes 1, 1.5, 2, 2.75, 3, 3.80, 4, and 5).

As used in this specification and the appended claims, the singular forms “a”, “an”, and “the” include the plural referents unless the content clearly dictates otherwise. As used in this specification and the appended claims, the term “or” is generally employed in its sense including “and/or” unless the content clearly dictates otherwise.

It is noted that references in the specification to “an embodiment”, “some embodiments”, “other embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is contemplated that the feature, structure, or characteristic may be applied to other embodiments whether or not explicitly described unless clearly stated to the contrary.

Firmware files used in Building Management System (BMS) Field devices (e.g. edge devices) can be large and can require substantial amounts of time and resources to transfer updated firmware files from time to time to the BMS Field devices over a field bus. When BMS field bus devices are not directly accessible to a Firmware (FW) engineering tool, for example only accessible through a connected BMS controller (e.g. through a Room Controller, Plant Controller, Supervisor PCs), then the firmware file transfer must happen through these BMS controller. In this, the BMS Controller may be a BMS controller of a distributed BMS control system that is configured to provide supervisory control over the connected BMS field devices during normal operation of the BMS system.

As a result, a firmware update may require two separate file downloads including a first download that downloads the updated firmware files from the FW engineering tool to the connected BMS Controller, and a second download from the BMS Controller to the respective BMS field devices via the BMS field bus. If the firmware stored in a particular BMS field device is the same as the firmware update to be installed, then time and resources are wasted downloading the firmware files to the BMS Controller and/or to the BMS field device because the particular BMS field device is already running the most recent version of the firmware. This disclosure addresses this problem by intelligently identifying the current version of the firmware running on the BMS field devices, and reporting this information to the FW engineering tool via the intervening BMS Controller. The FW engineering tool may then only download the necessary FW files to the BMS Controller, and the BMS Controller may only download the necessary FW files to the respective BMS field devices, saving time and system resources.

In some cases, a FW management protocol may be established and enforced for communication between each BMS field device and its respective BMS Controller, and between the BMS Controller and the FW engineering tool. In some cases, the FW management protocol may define a firmware file structure. In some cases, the firmware file structure may include a file header that includes details such as the firmware version, intended device information, file parity, file length in bytes, etc. The FW management protocol may further define communication commands between the BMS Controller the its connected BMS field devices. For example, in some cases, each BMS field device may, upon receiving a FW version request from its connected BMS Controller in accordance with the FW management protocol, report its current firmware version to its connected BMS Controller. In some cases, the system has in-built intelligence to notify, prevent and/or stop a firmware file download that is unnecessary, thereby saving time and system resources.

In some cases, the user of the FW engineering tool may be allowed to select one or more BMS Controllers for downloading firmware for their connected BMS Field Devices. The FW Application Tool may query the selected one or more BMS controllers to retrieve the current FW version of their respective BMS field devices. Once this information is received from the selected BMS Controllers, the FW Application Tool may cache this information. Armed with this information, the FW Application Tool has in-built intelligence to identify which BMS Field Devices need an updated FW version. In some cases, the FW Application Tool may have in-built intelligence to notify, prevent and/or stop a firmware file download to the BMS Controllers and/or the BMS field devices that are not necessary.

In some cases, a firmware package for a particular BMS field device may include two or more firmware files (e.g. one firmware file for each Micro Controller Units (MCU) of the BMS field device). The Application Tool may pick one by one of these firmware files from the firmware package (*.fw file). The FW Application Tool may identify whether the firmware file is valid for download (verify based on BMS field device information and firmware version) or not. If the firmware file is valid for download, then the FW Application Tool may download the firmware file to the particular BMS controller that the BMS field device is connected. After initiating the download of the firmware file, the FW Application Tool may wait for the download to complete and in the meantime work with another of the selected BMS Controllers. If there are more firmware files in the firmware package, then once the first firmware file is downloaded by BMS Controller, a next firmware file from the package may be downloaded to the BMS Controller. This may be continued until all of the firmware files from the packages have been downloaded to the BMS Controller.

Once all files from the firmware packages are successfully downloaded to all the selected BMS controllers, the user is allowed to disconnect the Application Tool from the network. In some cases, the selected BMS controllers are capable of downloading the firmware files received from the FW Application Tool to the appropriate connected Peripheral/field devices without the assistance of the FW Application Tool. Once gain connected, the FW Application Tool can show the download result to a user of the FW Application tool.

In one particular example, a system includes a Building Management System (BMS) controller and a plurality of BMS Field devices that are operatively coupled to the BMS controller via a field bus. The field bus may operate in accordance with a bus protocol, such as one of BacNet, Modbus, Sylk, FOX, LON, and panel bus. These are just examples. A Firmware (FW) management tool (e.g. a FW Application Tool) is operatively coupled to the BMS controller via a network connection (e.g. BacNet, Modbus, Sylk, FOX, LON, panel bus, Internet Protocol (IP), WiFi, etc.), sometimes through one or more intervening BMS Controllers. The FW management tool may be hosted on a personal computer, a server, a mobile device and/or any other suitable device.

The BMS controller is configured to send a request over the field bus to each of the plurality of BMS field devices connected to the BMS controller requesting device information including a current FW version of the respective BMS field device. In response to the request from the BMS controller, each of the plurality of BMS field devices is configured to return the requested device information including the current FW version of the respective BMS field device to the BMS controller via the field bus. In some instances, the device information that is returned to the BMS controller may include the current FW version of the respective BMS field device and at least one of a device identifier, a model identifier and a manufacturer identifier. As an example, the device identifier may include one or more of a serial number, a MAC address, and a device tag. The device tag may include a device descriptor or device code. In some cases, the device information that is returned to the BMS controller may include the current FW version for each of two or more Micro Controller Units (MCU) of the respective BMS field device, along with an MCU identifier for each of the two or more MCUs.

In one example, the BMS controller is configured to send at least some of the device information including the current FW version of each of the plurality of BMS field devices to the FW management tool. After receiving the device information including the current FW version of each of the plurality of BMS field devices, the FW management tool is configured to determine which of the plurality of BMS field devices have an outdated FW version. This may be accomplished by, for example, comparing the current FW version for the particular BMS field device with a most recent FW version for that particular BMS field device. The FW management tool is configured to send to the BMS controller one or more updated FW versions to update only those BMS field devices identified by the FW management tool as having an outdated FW version. In response to receiving the one or more updated FW versions for updating the plurality of BMS field devices identified by the FW management tool as having an outdated FW version, the BMS controller is configured to download the respective updated FW version to the respective BMS field device via the field bus. After receiving the respective updated FW version, each of the plurality of BMS field devices identified by the FW management tool as having an outdated FW version is configured to install the respective updated FW version.

In some cases, after successfully installing the respective updated FW version, each of the plurality of BMS field devices identified by the FW management tool as having an outdated FW version may be configured to notify the BMS controller of the successful FW installation. In some cases, after being notified by the respective BMS field devices of successfully installing the respective updated FW version, the BMS controller may be configured to notify the FW management tool of the respective successful FW installations. In some cases, the respective BMS field devices that have successfully installed the respective updated FW version are rebooted using the updated FW version. In some cases, the respective BMS field devices are automatically rebooted after successful FW installations, while in other cases, the BMS controller sends a reboot command to each of the respective BMS field devices that have successfully installed the respective updated FW version.

In some cases, the FW management tool may be configured to be disconnectable from the BMS controller after the FW management tool sends the one or more updated FW versions to update each of the plurality of BMS field devices identified by the FW management tool as having an outdated FW version to the BMS controller, without disrupting a successful installation of the respective updated FW version on each of the plurality of BMS field devices identified by the FW management tool as having an outdated FW version. In some cases, the FW management tool may be configured to be disconnectable from the BMS controller before the BMS controller is able to complete sending the updated FW version for each of the plurality of BMS field devices identified by the FW management tool as having an outdated FW version to the respective BMS field device via the field bus, without disrupting a successful installation of the respective updated FW version on each of the plurality of BMS field devices identified by the FW management tool as having an outdated FW version.

In some case, the updated FW version for a particular one of the plurality of BMS field devices includes a FW package with two or more FW files, and wherein the FW management tool may be configured to send the two more FW files for the particular one of the plurality of BMS field devices to the BMS controller sequentially, waiting for one to be completely downloaded to the BMS controller before beginning the next. In some cases, the FW management tool may be configured to sequentially send the one or more updated FW versions for updating each of the plurality of BMS field devices identified by the FW management tool as having an outdated FW version to the BMS controller, waiting for one to be completely sent to the BMS controller before beginning to send the FW files that correspond to a next BMS field device.

An example method provides for updating firmware (FW) of a plurality of BMS field devices, wherein the plurality of BMS field devices are operatively coupled to a Building Management System (BMS) controller via a field bus, and wherein the BMS controller is operatively coupled to a firmware (FW) management tool via a network (sometimes through one or more intervening controllers). The illustrative method includes the BMS controller querying each of the plurality of BMS field devices that are operatively coupled to the BMS controller via the field bus for device information including a current FW version of the respective BMS field device, and the BMS controller sending at least some of the received device information including the current FW version of each of the plurality of BMS field devices to the FW management tool. The FW management tool determines which of the plurality of BMS field devices have an outdated FW version and sends one or more updated FW versions to update each of the plurality of BMS field devices identified by the FW management tool as having an outdated FW version to the BMS controller. The BMS controller is configured to route the one or more updated FW versions received from the FW management tool to the respective BMS field devices via the field bus.

After receiving the respective updated FW version, each of the plurality of BMS field devices identified by the FW management tool as having an outdated FW version may install the respective updated FW version. In some cases, after successfully installing the respective updated FW version, each of the plurality of BMS field devices identified by the FW management tool as having an outdated FW version may notify the BMS controller of the successful installation. In some cases, after being notified by the respective BMS field devices of successfully installing the respective updated FW version, the BMS controller may notify the FW management tool of the respective successful installations. In some cases, the method may include disconnecting the FW management tool from the BMS controller after the FW management tool sends the one or more updated FW versions to update each of the plurality of BMS field devices identified by the FW management tool as having an outdated FW version to the BMS controller, but this is not required.

A non-transitory computer readable medium may store instructions that when executed by one or more processors of a BMS controller causes the one or more processors of a

BMS controller to query each of a plurality of BMS field devices that are operatively coupled to the BMS controller for device information including a current FW version of the respective BMS field device. The one or more processors of the BMS controller are caused to send at least some of the received device information including the current FW version of each of the plurality of BMS field devices to a firmware (FW) management tool. The one or more processors of the BMS controller are caused to receive from the FW management tool one or more updated FW versions to update one or more of a plurality of BMS field devices identified by the FW management tool as having an outdated FW version. The one or more processors of the BMS controller are caused to route the one or more updated FW versions to the respective BMS field devices identified by the FW management tool as having an outdated FW version.

In some cases, the one or more processors of the BMS controller are caused to receive a notification of a successful installation of the respective updated FW version from each of at least one of the plurality of BMS field devices identified by the FW management tool as having an outdated FW version. In some cases, the one or more processors of the BMS controller are caused to, after routing a respective updated FW version to a respective BMS field device, send a firmware update command to the respective BMS field device that instructs the respective BMS field device to install the respective updated FW version. In some cases, the one or more processors of the BMS controller are caused to, after receiving a notification of the successful installation of the respective updated FW version from each of at least one of the plurality of BMS field devices identified by the FW management tool as having an outdated FW version, send a notification to the FW management tool notifying the FW management tool of the successful installation.

In some cases, a resiliency use case refers to a situation in which a hardware change leads to incompatible firmware changes. In the case of resiliency, the field device may need to expose a new device tag, model number and/or other field device identifier. For example, a legacy field device having a single MCU may be replaced with an updated field device having two MCU's for increased performance. The firmware for the updated field device that supports two MCU's will not be compatible with the firmware of the legacy field device that only supports a single MCU. In this case, once the updated field device is installed, the BMS Controller may receive device information including a device type of the updated field device and the current FW version of the updated field device. In some cases, the device information that is provided to the BMS controller may include the current FW version for each of the two MCUs of the updated field device, along with an MCU identifier for each of the two or more MCUs. This may be provided to the FW management tool, which may identify appropriate updated FW versions for the updated field device and download the identify appropriate updated FW versions to the BMS Controller, which may in turn download the appropriate updated FW versions to the updated field device when necessary.

In some cases, certain commands may be used during firmware downloads. Example commands are outlined in Table One below:

TABLE ONE

| Command Value | |
|---|---|
| (1 byte) | Description of the Command |
| 0x00 | Unlock the file and ready to accept the |
| | file transfer. |
| 0x01 | File transfer complete, lock the file. |
| 0x02 | Perform the updates for all the received |
| | firmware files. |
| 0x03 | Cancel command. This command shall be sent |
| | to the field device by tool or BMS controller |
| | when user cancels the firmware download. |

The firmware file download status may be described as shown in Table Two below:

TABLE TWO

| | | Status Response |
|---|---|---|
| Status Value | | generated from |
| (1 byte) | Description of the Status | device |
| 0x00 | Last firmware file update success | Field device |
| | and in normal working condition | |
| | and running last received firmware. | |
| 0x01 | Last received firmware file validation | Field device |
| | failed (Ex: header CRC, invalid header | |
| | version, invalid header format, | |
| | running previous firmware version. | |
| 0x02 | Last received firmware file update | Field device |
| | failed, running previous firmware | |
| | version. | |
| 0x03 | Firmware file update in progress. | Field device |
| 0x04 | Once the file is given to the BMS | BMS Controller |
| | Controller, transfer from the BMS | |
| | controller to field device is failed. | |
| | Since the file transfer itself if | |
| | failed, this status will never by | |
| | reported by the field device. This | |
| | status I ok between BMS controller | |
| | and the tools. | |
| 0x05 | Signature validation failed for the | Field device |
| | downloaded file. | |
| 0x06 | Flash access failed - this is not | Field device |
| | specific to host MCU, this status | |
| | is applicable to the file which is | |
| | currently downloaded. | |
| 0x07 | Status Register Read failed. This | BMS Controller |
| | is used by BMS controller to update | |
| | the status back to the tools. | |
| 0x08 | Field device is not responding. | BMS Controller |
| | Most probably Field device is | |
| | either disconnected or powered | |
| | down - this is used by BMS | |
| | controller to update the status | |
| | back to the tools. | |
| 0x09 | Provisioning period. Field device | Field device |
| | just completed updating the given | |
| | firmware successfully and it is | |
| | currently performing housekeeping | |
| | tasks for the new downloaded | |
| | firmware like RTOS task deadlock, | |
| | infinite loop, etc. | |
| | At this state field device shall | |
| | not accept new firmware download | |
| | and the clients to handle this | |
| | state and report proper error | |
| | message to user, so user can try | |
| | the firmware download after some | |
| | time. | |
| 0xFF | Field device not compatible with | |
| | the given firmware- that is used | |
| | by BMS controller to update the | |
| | status back to the tools. | |

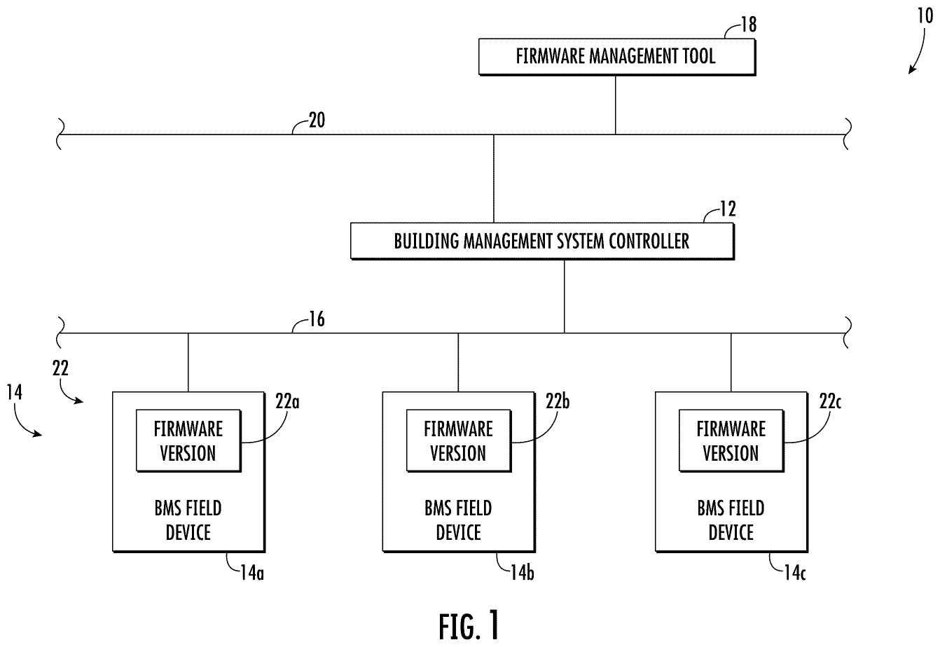

Turning specifically to the drawings, FIG. 1 is a schematic block diagram showing an illustrative system 10. The illustrative system 10 includes a Building Management System (BMS) controller 12 and a plurality of BMS field devices 14. The BMS controller 12 may represent any of a unitary controller, a plant controller and/or any other suitable Building Management System Controller. While a total of three BMS field devices 14 are shown, this is merely illustrative as the system 10 may include any number of BMS field devices 14, and in some cases may include considerably more than three BMS field devices 14. The BMS field devices 14 are operatively coupled to the BMS controller 12 via a field bus 16. The field bus 16 may represent any of a variety of different field bus protocols, including but not limited to BacNet, Modbus, Sylk, FOX, LON, and panel bus, for example. In some cases, some of the BMS field devices 14 may be operatively coupled to the BMS controller 12 via a first field bus using a first field bus protocol and other of the BMS field devices 14 may be operatively coupled to the BMS controller 12 via a second field bus using a second field bus protocol. In the example shown in FIG. 1, the field bus 16 may represent one field bus or two or more field busses, depending on the architecture of the system 10.

Each of the BMS field devices 14, which may individually represent any of a sensor such as a smart sensor, an actuator such as a smart actuator, a snap-on IO devices, a unitary or lower level BMS controller, and/or any other suitable device. A firmware management tool 18 is operatively coupled to the BMS controller 12 via a network connection 20 and sometimes through one or more intervening controllers (not explicitly shown in FIG. 1). The firmware management tool 18 may remain operatively coupled to the BMS controller 12 at all times. In some cases, the firmware management tool 18 may only be operatively coupled to the BMS controller 12 when firmware updates are desired.

The BMS controller 12 is configured to send a request over the field bus 16 to each of the plurality of BMS field devices 14 requesting device information including a current FW version 22, individually labeled as 22a, 22b, and 22c, of the respective BMS field device 14. In response to the request from the BMS controller over the field bus 16, each of the plurality of BMS field devices 14 is configured to return the requested device information including the current FW version 22 of the respective BMS field device 14 to the BMS controller 12 via the field bus 16.

In some cases, the device information that is returned to the BMS controller 12 may include the current FW version of the respective BMS field device 14 and at least one of a device identifier, a model identifier and a manufacturer identifier. In some cases, the device identifier may include one or more of a serial number, a MAC address, and a device tag. In some cases, the device information that is returned to the BMS controller 12 may include the current FW version for each of two or more Micro Controller Units (MCU) of the respective BMS field device 14, along with an identifier for each of the two or more MCUs. These are just examples.

The BMS controller 12 is configured to send at least some of the device information including the current FW version 22 of each of the plurality of BMS field devices 14 to the FW management tool 18. After receiving the device information including the current FW version 22 of each of the plurality of BMS field devices 14, the FW management tool 18 is configured to determine which of the plurality of BMS field devices 14 have an outdated FW version. The FW management tool 18 may store a FW database or have access to a FW database that identifies the current FW version for each of a plurality of field devices. The FW management tool 18 is configured to send one or more updated FW versions to update only those of the plurality of BMS field devices 14 identified by the FW management tool 18 as having an outdated FW version to the BMS controller 12. In response to receiving the one or more updated FW versions for updating the plurality of BMS field devices 14 identified by the FW management tool 18 as having an outdated FW version, the BMS controller 12 is configured to send the respective updated FW version to the respective BMS field device 14 via the field bus 16. After receiving the respective updated FW version, each of the plurality of BMS field devices 14 identified by the FW management tool 18 as having an outdated FW version is configured to install the respective updated FW version. In some cases, each of the plurality of BMS field devices 14 are rebooted after the respective updated FW version are installed.

In some cases, after successfully installing the respective updated FW version, each of the plurality of BMS field devices 14 identified by the FW management tool as having an outdated FW version may be configured to notify the BMS controller 12 of the successful installation. In some cases, after being notified by the respective BMS field devices 14 of successfully installing the respective updated FW version, the BMS controller 12 may be configured to notify the FW management tool 18 of the respective successful installations.

In some cases, the FW management tool 18 may be configured to be disconnectable from the BMS controller 12 after the FW management tool 18 sends the one or more updated FW versions to update each of the plurality of BMS field devices 14 identified by the FW management tool 18 as having an outdated FW version to the BMS controller 12 without disrupting a successful installation of the respective updated FW version on each of the plurality of BMS field devices 14 identified by the FW management tool 18 as having an outdated FW version. In some cases, the FW management tool 18 may be configured to be disconnectable from the BMS controller 12 even before the BMS controller 12 is able to complete sending the updated FW version for each of the plurality of BMS field devices 14 identified by the FW management tool 18 as having an outdated FW version to the respective BMS field device 14 via the field bus 16 without disrupting a successful installation of the respective updated FW version on each of the plurality of BMS field devices 14 identified by the FW management tool 18 as having an outdated FW version.

In some cases, the updated FW version for a particular one of the plurality of BMS field devices 14 may include a FW package with two or more FW files, wherein the FW management tool 18 may be configured to send the two more FW files for the particular one of the plurality of BMS field devices 14 to the BMS controller 12 sequentially, waiting for one to be completely sent to the BMS controller 12 before beginning the next. In some cases, the FW management tool 18 may be configured to sequentially send the one or more updated FW versions for updating each of the plurality of BMS field devices 14 identified by the FW management tool 18 as having an outdated FW version to the BMS controller 12, waiting for one to be completely sent to the BMS controller 12 before beginning the next.

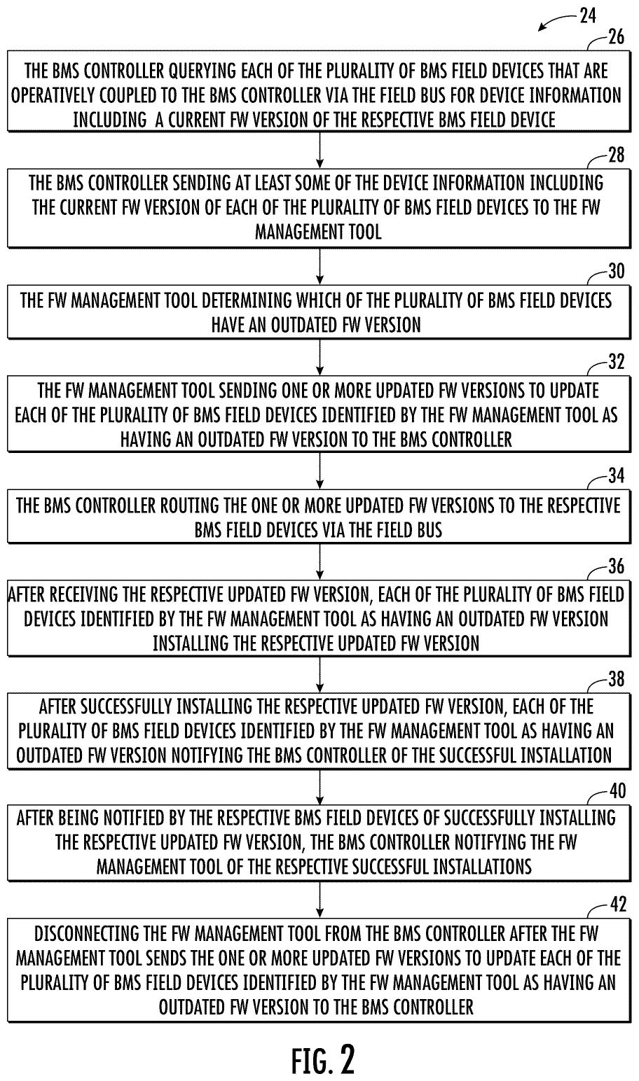

FIG. 2 is a flow diagram showing a method 24 for updating firmware (FW) of a plurality of BMS field devices (such as the BMS field devices 14). The plurality of BMS field devices are operatively coupled to a Building Management System (BMS) controller (such as the BMS controller 12) via a field bus (such as the field bus 16). The BMS controller is operatively coupled to a firmware (FW) management tool (such as the firmware management tool 18) via a network such as the network 20. The illustrative method 24 includes the BMS controller querying each of the plurality of BMS field devices that are operatively coupled to the BMS controller via the field bus for device information including a current FW version of the respective BMS field device, as indicated at block 26. The BMS controller sends at least some of the device information including the current FW version of each of the plurality of BMS field devices to the FW management tool, as indicated at block 28. The FW management tool determines which of the plurality of BMS field devices have an outdated FW version, as indicated at block 30. The FW management tool sends one or more updated FW versions to update each of the plurality of BMS field devices identified by the FW management tool as having an outdated FW version to the BMS controller, as indicated at block 32. The BMS controller routes the one or more updated FW versions to the respective BMS field devices via the field bus, as indicated at block 34.

In some cases, after receiving the respective updated FW version, each of the plurality of BMS field devices identified by the FW management tool as having an outdated FW version install the respective updated FW version, as indicated at block 36. In some cases, installing the respective updated FW version may include a reboot and/or power cycling of the respective BMS field device. In some cases, after successfully installing the respective updated FW version, each of the plurality of BMS field devices identified by the FW management tool as having an outdated FW version notify the BMS controller of the successful installation, as indicated at block 38. In some cases, after being notified by the respective BMS field devices of successfully installing the respective updated FW version, the BMS controller notifies the FW management tool of the respective successful installations, as indicated at block 40. In some cases, the method 24 may further include disconnecting the FW management tool from the BMS controller after the FW management tool sends the one or more updated FW versions to update each of the plurality of BMS field devices identified by the FW management tool as having an outdated FW version to the BMS controller, as indicated at block 42.

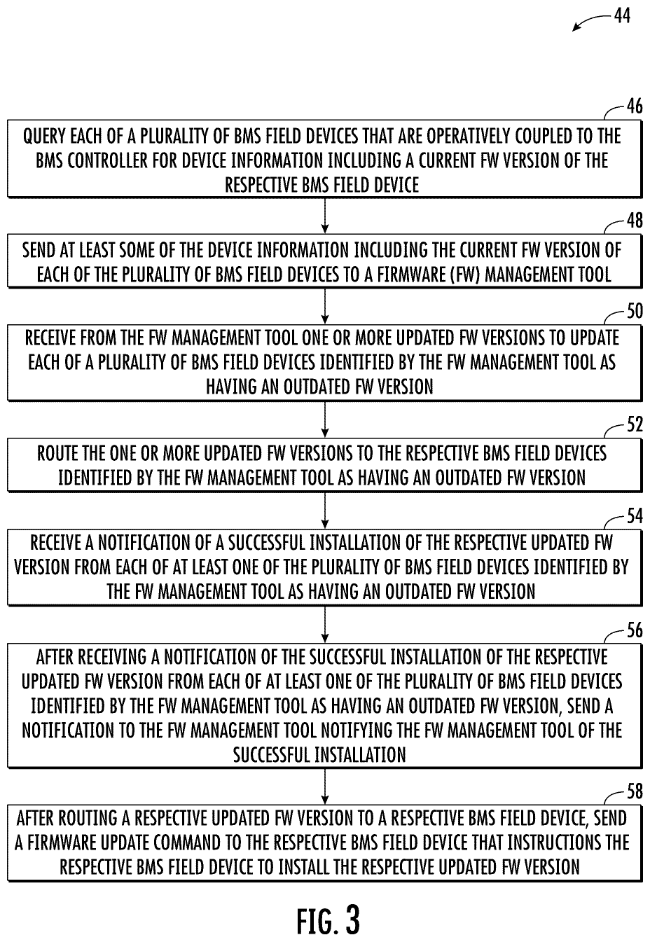

FIG. 3 is a flow diagram showing an illustrative series of steps 44 that may be carried out by one or more processors of a BMS controller (such as the BMS controller 12). The one or more processors are caused to query each of a plurality of BMS field devices that are operatively coupled to the BMS controller for device information including a current FW version of the respective BMS field device, as indicated at block 46. The one or more processors are caused to send at least some of the device information including the current FW version of each of the plurality of BMS field devices to a firmware (FW) management tool, as indicated at block 48. The one or more processors are caused to receive from the FW management tool one or more updated FW versions to update each of a plurality of BMS field devices identified by the FW management tool as having an outdated FW version, as indicated at block 50. The one or more processors are caused to route the one or more updated FW versions to the respective BMS field devices identified by the FW management tool as having an outdated FW version, as indicated at block 52.

In some cases, the one or more processors may be caused to receive a notification of a successful installation of the respective updated FW version from each of at least one of the plurality of BMS field devices identified by the FW management tool as having an outdated FW version, as indicated at block 54. In some cases, the one or more processors may be caused to after receiving a notification of the successful installation of the respective updated FW version from each of at least one of the plurality of BMS field devices identified by the FW management tool as having an outdated FW version, send a notification to the FW management tool notifying the FW management tool of the successful installation, as indicated at block 56. In some cases, the one or more processors may be caused to after routing a respective updated FW version to a respective BMS field device, send a firmware update command to the respective BMS field device that instructions the respective BMS field device to install the respective updated FW version, as indicated at block 58.

Having thus described several illustrative embodiments of the present disclosure, those of skill in the art will readily appreciate that yet other embodiments may be made and used within the scope of the claims hereto attached. It will be understood, however, that this disclosure is, in many respects, only illustrative. Changes may be made in details, particularly in matters of shape, size, arrangement of parts, and exclusion and order of steps, without exceeding the scope of the disclosure. The disclosure's scope is, of course, defined in the language in which the appended claims are expressed.

What is claimed is:

1. A system comprising:
a Building Management System (BMS) controller;
a plurality of BMS Field devices operatively coupled to the BMS controller via a field bus;
a firmware (FW) management tool operatively coupled to the BMS controller via a network connection;
the BMS controller is configured to send a request over the field bus to each of the plurality of BMS field devices requesting device information including a current FW version of the respective BMS field device;
in response to the request from the BMS controller over the field bus, each of the plurality of BMS field devices is configured to return the requested device information including the current FW version of the respective BMS field device to the BMS controller via the field bus;
the BMS controller is configured to send at least some of the device information including the current FW version of each of the plurality of BMS field devices to the FW management tool;
after receiving the device information including the current FW version of each of the plurality of BMS field devices, the FW management tool configured to determine which of the plurality of BMS field devices have an outdated FW version;
the FW management tool is configured to send one or more updated FW versions to update each of the plurality of BMS field devices identified by the FW management tool as having an outdated FW version to the BMS controller;
in response to receiving the one or more updated FW versions for updating the plurality of BMS field devices identified by the FW management tool as having an outdated FW version, the BMS controller is configured to send the respective updated FW version to the respective BMS field device via the field bus; and
after receiving the respective updated FW version, each of the plurality of BMS field devices identified by the FW management tool as having an outdated FW version is configured to install the respective updated FW version.

2. The system of claim 1, wherein after successfully installing the respective updated FW version, each of the plurality of BMS field devices identified by the FW management tool as having an outdated FW version is configured to notify the BMS controller of the successful installation.

3. The system of claim 1, wherein after being notified by the respective BMS field devices of successfully installing the respective updated FW version, the BMS controller is configured to notify the FW management tool of the respective successful installations.

4. The system of claim 1, wherein the FW management tool is configured to be disconnectable from the BMS controller after the FW management tool sends the one or more updated FW versions to update each of the plurality of BMS field devices identified by the FW management tool as having an outdated FW version to the BMS controller without disrupting a successful installation of the respective updated FW version on each of the plurality of BMS field devices identified by the FW management tool as having an outdated FW version.

5. The system of claim 1, wherein the FW management tool is configured to be disconnectable from the BMS controller even before the BMS controller is able to complete sending the updated FW version for each of the plurality of BMS field devices identified by the FW management tool as having an outdated FW version to the respective BMS field device via the field bus without disrupting a successful installation of the respective updated FW version on each of the plurality of BMS field devices identified by the FW management tool as having an outdated FW version.

6. The system of claim 1, wherein the updated FW version for a particular one of the plurality of BMS field devices includes a FW package with two or more FW files, wherein the FW management tool is configured to send the two more FW files for the particular one of the plurality of BMS field devices to the BMS controller sequentially, waiting for one to be completely sent to the BMS controller before beginning the next.

7. The system of claim 1, wherein the FW management tool is configured to sequentially send the one or more updated FW versions for updating each of the plurality of BMS field devices identified by the FW management tool as having an outdated FW version to the BMS controller, waiting for one to be completely sent to the BMS controller before beginning the next.

8. The system of claim 1, wherein the device information that is returned to the BMS controller includes the current FW version of the respective BMS field device and at least one of a device identifier, a model identifier and a manufacturer identifier.

9. The system of claim 8, wherein the device identifier includes one or more of a serial number, a MAC address, and a device tag.

10. The system of claim 1, wherein the device information that is returned to the BMS controller includes the current FW version for each of two or more Micro Controller Units (MCU) of the respective BMS field device, along with an identifier for each of the two or more MCUs.

11. The system of claim 1, wherein the field bus operates in accordance with a bus protocol, wherein the bus protocol is one of BacNet, Modbus, Sylk, FOX, LON, and panel bus.

12. A method for updating firmware (FW) of a plurality of BMS field devices, wherein the plurality of BMS field devices are operatively coupled to a Building Management System (BMS) controller via a field bus, and wherein the BMS controller is operatively coupled to a firmware (FW) management tool via a network, the method comprising:
the BMS controller querying each of the plurality of BMS field devices that are operatively coupled to the BMS controller via the field bus for device information including a current FW version of the respective BMS field device;
the BMS controller sending at least some of the device information including the current FW version of each of the plurality of BMS field devices to the FW management tool;
the FW management tool determining which of the plurality of BMS field devices have an outdated FW version;
the FW management tool sending one or more updated FW versions to update each of the plurality of BMS field devices identified by the FW management tool as having an outdated FW version to the BMS controller; and
the BMS controller routing the one or more updated FW versions to the respective BMS field devices via the field bus.

13. The method of claim 12, wherein after receiving the respective updated FW version, each of the plurality of BMS field devices identified by the FW management tool as having an outdated FW version installing the respective updated FW version.

14. The method of claim 13, wherein after successfully installing the respective updated FW version, each of the plurality of BMS field devices identified by the FW management tool as having an outdated FW version notifying the BMS controller of the successful installation.

15. The method of claim 14, wherein after being notified by the respective BMS field devices of successfully installing the respective updated FW version, the BMS controller notifying the FW management tool of the respective successful installations.

16. The method of claim 12 comprising:
disconnecting the FW management tool from the BMS controller after the FW management tool sends the one or more updated FW versions to update each of the plurality of BMS field devices identified by the FW management tool as having an outdated FW version to the BMS controller.

17. A non-transitory computer readable medium storing instructions that when executed by one or more processors of a BMS controller causes the one or more processors to:
query each of a plurality of BMS field devices that are operatively coupled to the BMS controller for device information including a current FW version of the respective BMS field device;
send at least some of the device information including the current FW version of each of the plurality of BMS field devices to a firmware (FW) management tool;
receive from the FW management tool one or more updated FW versions to update each of a plurality of BMS field devices identified by the FW management tool as having an outdated FW version; and
route the one or more updated FW versions to the respective BMS field devices identified by the FW management tool as having an outdated FW version.

18. The non-transitory computer readable medium of claim 17, wherein the instructions cause the one or more processors to:
receive a notification of a successful installation of the respective updated FW version from each of at least one of the plurality of BMS field devices identified by the FW management tool as having an outdated FW version.

19. The non-transitory computer readable medium of claim 18, wherein the instructions cause the one or more processors to:
after receiving a notification of the successful installation of the respective updated FW version from each of at least one of the plurality of BMS field devices identified by the FW management tool as having an outdated FW version, send a notification to the FW management tool notifying the FW management tool of the successful installation.

20. The non-transitory computer readable medium of claim 17, wherein the instructions cause the one or more processors to:
after routing a respective updated FW version to a respective BMS field device, send a firmware update command to the respective BMS field device that instructions the respective BMS field device to install the respective updated FW version.
